(19) United States
(12) Patent Application Publication
(10) Pub. No.: US 2015/0234448 A1
(43) Pub. Date: Aug. 20, 2015

(54) INFORMATION PROCESSING SYSTEM AND STORAGE DEVICE

(71) Applicant: Kabushiki Kaisha Toshiba, Minato-ku (JP)

(72) Inventors: Makoto ICHIDA, Yokohama-Shi (JP); Norikazu YOSHIDA, Kawasaki-shi (JP)

(73) Assignee: Kabushiki Kaisha Toshiba, Minato-ku (JP)

(21) Appl. No.: 14/278,488

(22) Filed: May 15, 2014

Related U.S. Application Data
(60) Provisional application No. 61/941,042, filed on Feb. 18, 2014.

(51) Int. Cl. G06F 1/32; G06F 3/06

(52) U.S. Cl. CPC G06F 1/3268; G06F 3/0688; G06F 3/0689; G06F 3/0665; G06F 3/0659; G06F 3/0625; G06F 3/0634; G06F 1/3275; G06F 2003/0692

(57) ABSTRACT

According to one embodiment, an information processing system includes a first storage device, a second storage device, and a host device that controls the first and second storage devices. When a first condition is satisfied, the host device transfers data stored in the first storage device to the second storage device, and thereafter, turns off the first storage device. When it is required to perform data processing by the first storage device, the host device turns on the first storage device.

### CROSS-REFERENCE TO RELATED APPLICATIONS

This application is based upon and claims the benefit of priority from U.S. Provisional Application No. 61/941,042, filed on Feb. 18, 2014; the entire contents of which are incorporated herein by reference.

### FIELD

Embodiments described herein relate generally to an information processing system and a storage device.

### BACKGROUND

In an information processing system in which a plurality of data storage devices such as an SSD (Solid State Drive) and an HDD (Hard Disk Drive) are connected, each data storage device is connected to a host via a network and the like. In such an information processing system, high-speed data write/read with low power consumption has been desired.

### BRIEF DESCRIPTION OF THE DRAWINGS

FIG. 1 illustrates a configuration of an information processing system according to a first embodiment;

FIG. 2 is a flowchart of an operation procedure of the information processing system according to the first embodiment;

FIG. 3 is an explanatory diagram of a data transfer process;

FIG. 4 illustrates a configuration of a memory system according to a second embodiment;

FIG. 5 is an explanatory diagram of power ON/OFF setting of a Channel; and

FIGS. 6A to 6F are explanatory diagrams of power ON/OFF setting in an SSD.

### DETAILED DESCRIPTION

In general, according to one embodiment, an information processing system includes a first storage device, a second storage device, and a host device that controls the first and second storage devices. When a first condition is satisfied, the host device transfers data stored in the first storage device to the second storage device, turns off the first storage device after the data transfer, and when it is required to perform data processing by the first storage device, turns on the first storage device.

Exemplary embodiments of an information processing system and a storage device will be explained below in detail with reference to the accompanying drawings. Explanations are given with an SSD and an HDD as an example of a storage device. The present invention is not limited to the following embodiments.

### First Embodiment

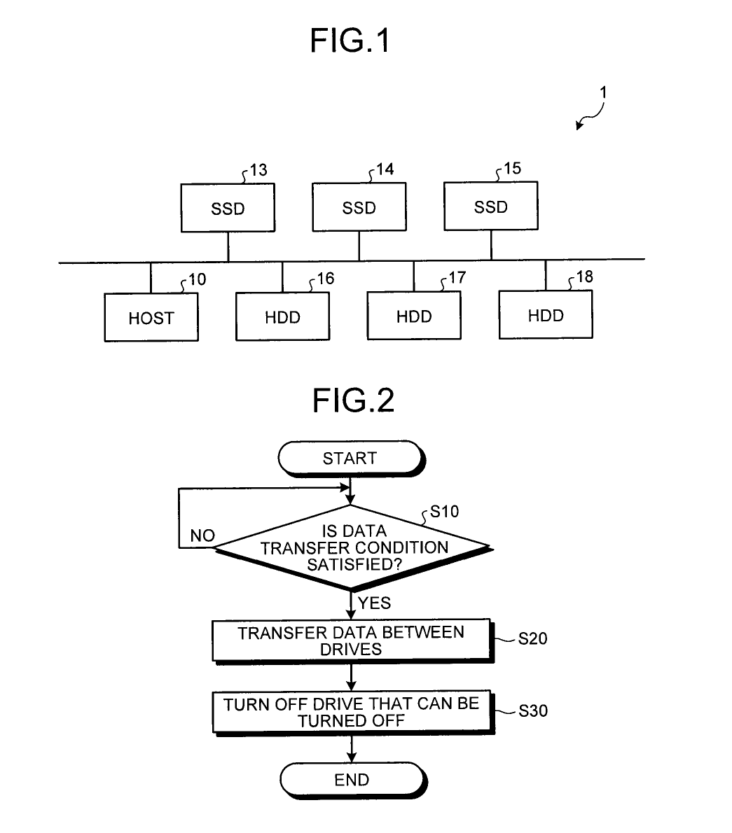

FIG. 1 illustrates a configuration of an information processing system according to a first embodiment. An information processing system 1 includes a host 10, SSDs (Solid State Drives) 13 to 15, and HDDs (Hard Disk Drives) 16 to 18. In the information processing system 1, the host 10, the SSDs 13 to 15, and the HDDs 16 to 18 are connected to each other via a network.

When a predetermined condition (data transfer condition) is satisfied, the host 10 transfers (makes them compact) all pieces of data stored in a transfer-source storage device from the transfer-source storage device to a transfer-destination storage device. The transfer-source storage device is one of the SSDs 13 to 15 and the HDDs 16 to 18, and the transfer-destination storage device is one of the SSDs 13 to 15 and the HDDs 16 to 18 different from the transfer-source storage device.

The data transfer condition includes, for example, (1) a condition related to power consumption for operating the storage device, (2) a condition related to the access frequency to the storage device, (3) a condition related to an amount of data stored in the storage device, and (4) a condition related to a data transfer speed (writing speed/reading speed) to/from the storage device.

(1) A Case of Using a Condition Related to Power Consumption for Operating the Storage Device

In this case, the host 10 sets a storage device having higher operating power consumption than a first power value as the transfer-source storage device. The power consumption for operating the storage device is different depending on whether the storage device is an SSD or an HDD, the rotation speed of an HDD disk, manufacturer, date of manufacture of the storage device, and the like. The host 10 sets a storage device having lower operating power consumption than a second power value as the transfer-destination storage device. The host 10 sets, for example, the HDDs 16 to 18 as the transfer-source storage devices, and the SSD 13 as the transfer-destination storage device. In the following explanations, the transfer-source storage device and the transfer-destination storage device may be referred to as “transfer-related storage device”.

(2) A Case of Using a Condition Related to the Access Frequency to the Storage Device

In this case, the host 10 sets a storage device having a lower access frequency in a predetermined period than a first value as the transfer-source storage device. Further, the host 10 sets a storage device having, for example, a higher access frequency in the predetermined period than a second value as the transfer-destination storage device. For example, the host 10 can set a storage device that has not been accessed in a first period as the transfer-source storage device, and can set a storage device that has been accessed in a second period as the transfer-destination storage device.

(3) A Case of Using a Condition Related to an Amount of Data Stored in the Storage Device

In this case, the host 10 sets a storage device having a smaller amount of data of stored available data than a first amount (for example, 10 gigabytes) as the transfer-source storage device, and sets a storage device having a larger amount of stored data than a second amount (for example, 10 gigabytes) as the transfer-destination storage device.

The host 10 can set a storage device having a lower ratio of amount of stored data to the entire storage capacity than a first ratio as the transfer-source storage device. Further, the host 10 can set a storage device having a higher ratio of amount of stored data to the entire storage capacity than a second ratio as the transfer-destination storage device.

The host 10 can set a storage device in which the amount of stored data has increased to a predetermined amount as the transfer-source storage device. In this case, the host 10 can set a storage device in which the amount of stored data has increased to the predetermined amount and then decreased to the first amount as the transfer-source storage device.

The host 10 can change the second amount based on the amount of data of the transfer-source storage device. For example, when the amount of data of the transfer-source storage device is 3 gigabytes, the host 10 can change the second amount from 10 gigabytes to 3 gigabytes.

The host 10 can change the first amount based on the storage capacity remaining in the transfer-destination storage device. For example, when the storage capacity remaining in the transfer-destination storage device is 15 gigabytes, the host 10 can change the first amount from 10 gigabytes to 15 gigabytes.

(4) A Case of Using a Condition Related to a Data Transfer Speed to the Storage Device

In this case, the host 10 sets a storage device having a lower data transfer speed than a first speed as the transfer-source storage device, and sets a storage device having a higher data transfer speed than a second speed as the transfer-destination storage device. The transfer speed of the storage device is different depending on whether the storage device is an SSD or an HDD, the rotation speed of an HDD disk, and a host interface or the like of the storage device.

For example, the host 10 sets a storage device having an SATA interface or an SAS interface as the transfer-source storage device, and a storage device having a PCIe interface (I/F) as the transfer-destination storage device.

When using any of the conditions (1) to (4), the host 10 can set the transfer-source storage device and the transfer-destination storage device while ignoring the other conditions. For example, when using the condition (1), (2), or (4), the host 10 can transfer data from a storage device having a larger amount of stored data to a storage device having a smaller amount of stored data.

The host 10 can set only the transfer-source storage device based on at least one of the conditions (1) to (4). In this case, the host 10 sets storage devices other than the transfer-source storage device as the transfer-destination storage devices.

The host 10 can set only the transfer-destination storage device based on at least one of the conditions (1) to (4). In this case, the host 10 sets storage devices other than the transfer-destination storage device as the transfer-source storage devices.

The host 10 can set a plurality of transfer-source storage devices or a plurality of transfer-destination storage devices. When a plurality of transfer-source storage devices have been set, the host 10 can transfer the pieces of data in the respective transfer-source storage devices collectively to the transfer-destination storage device. When the predetermined condition is satisfied, the host 10 transfers the pieces of data in the respective transfer-source storage devices collectively to the transfer-destination storage device.

When a plurality of transfer-destination storage devices have been set, the host 10 can divide the data in the transfer-source storage device and transfer the divided data to any of the transfer-destination storage devices. When the predetermined condition is satisfied, the host 10 divides the data in the transfer-source storage device and transfers the data to any of the transfer-destination storage devices.

When a part of data in the transfer-source storage device cannot be stored in the transfer-destination storage device, the host 10 can set a new transfer-destination storage device based on other conditions.

The host 10 can set a transfer-related storage device by using a plurality of conditions (1) to (4). The host 10 can weigh the respective conditions (1) to (4) to use the conditions in combination. In this case, the host 10 sets a transfer priority based on the magnitude of operating power consumption (a value indicating the priority of transfer), a transfer priority based on the access frequency, a transfer priority based on the amount of stored data, and a transfer priority based on the data transfer speed. The host 10 adds the transfer priority for each storage device, and sets the transfer-source storage device and the transfer-destination storage device based on a result of addition (a total value). The host 10 sets a storage device having a lower total value of transfer priority than a predetermined value as the transfer-source storage device, and sets a storage device having a higher total value of transfer priority than the predetermined value as the transfer-destination storage device.

After completion of transfer of data stored in the transfer-source storage device, the transfer-source storage device is not necessarily required for the operation of the information processing system 1. Therefore, after completion of data transfer between the storage devices, the host 10 turns off the transfer-source storage device. At the time of turning off the storage device, the power can be turned off under the control by the host 10, or under the own control of the storage device having received a command instructing power-off from the host 10. The host 10 turns on the storage device when it is required to perform data processing with respect to the storage device that has been turned off.

In this manner, because the storage device not required for the operation of the information processing system 1, of the storage devices in the information processing system 1, is turned off, power consumption can be reduced without deteriorating the performance of the information processing system 1.

FIG. 2 is a flowchart of an operation procedure of the information processing system according to the first embodiment. In the information processing system 1, the host 10 determines whether the respective storage devices (the SSDs 13 to 15 and the HDDs 16 to 18) satisfy the data transfer condition (Step S10). The host 10 can determine whether the respective storage devices satisfy the data transfer condition at any timing.

(a) For example, the host 10 can perform a determination process when the information processing system 1 is turned on (at the time of startup).

(b) The host 10 can perform the determination process at each predetermined cycle.

(c) The host 10 can perform the determination process when the total amount of data to be stored in each storage device becomes larger than a predetermined amount.

(d) The host 10 can perform the determination process every time any of a reading process, a writing process, and a deleting process of data is completed.

(e) The host 10 can perform the determination process when the number of storage devices that is not a target of reading, writing, or deletion of data is a predetermined number or more. In this case, the host 10 determines a timing of performing the determination process based on a command scheduled to be transmitted to the storage device (a standby command).

(f) The host 10 can perform the determination process when any of the storage devices is formatted.

(g) The host 10 can perform the determination process when all the pieces of data written in any of the storage devices have a predetermined value such as “0” or “1”.

The host 10 can refer to the standby command to perform the determination process. In this case, the host 10 computes the data storage state of the storage device after executing the standby command, and performs the determination process based on a computation result.

When having determined that at least one of the transfer-source storage device and the transfer-destination storage device that satisfy the data transfer condition is not present (No at Step S10), the host 10 does not perform data transfer between the storage devices.

On the other hand, when having determined that both the transfer-source storage device and the transfer-destination storage device that satisfy the data transfer condition are present (Yes at Step S10), the host 10 transfers the data in the transfer-source storage device to the transfer-destination storage device (Step S20).

Thereafter, the host 10 turns off the storage device that can be turned off (the transfer-source storage device) (Step S30). When the amount of data stored in other storage devices increases and a free space decreases, the host 10 needs to use the storage device that has been turned off. In this case, the host 10 needs to perform writing or reading of data with respect to the storage device that has been turned off, and thus the host 10 turns on the storage device.

In this manner, the information processing system 1 sets the storage device having a small amount of stored data as the transfer-source storage device, and transfers the data in the transfer-source storage device to the transfer-destination storage device, which is another storage device. In other words, the information processing system 1 performs data compaction at a system level. Accordingly, because the information processing system 1 can create a blank storage device, the blank storage device can be turned off.

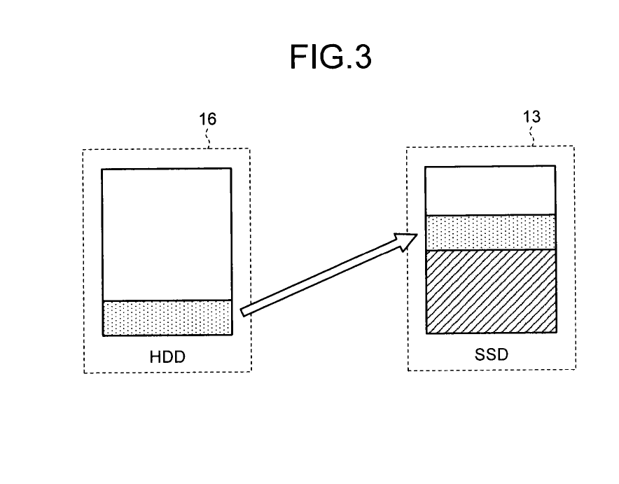

FIG. 3 is an explanatory diagram of the data transfer process. A case where the transfer-source storage device is the HDD 16, and the transfer-destination storage device is the SSD 13 is explained here. The host 10 transfers the data in the HDD 16 being the transfer-source storage device to the SSD 13 being the transfer-destination storage device.

Specifically, the host 10 copies the data in the HDD 16 and writes the data in the SSD 13. The host 10 then deletes the data in the HDD 16. Accordingly, the HDD 16 becomes a storage device with no stored data on it. The host 10 turns off the HDD 16 that has been empty. As a result, the information processing system 1 can reduce power consumption in the system without losing high-speed performance of data transfer.

The host 10 can use the storage devices in order from a storage device having lower power consumption. In this case, when there is no free space in a data storage area of the storage device having the lowest power consumption, the host 10 causes a storage device having the second lowest power consumption to store the data. When there is a free space in a storage device having the Xth (X is a natural number) lowest power consumption, and there is transferrable data in a storage device having the (X+1)th lowest power consumption, the host 10 performs data transfer.

The host 10 can use the storage devices in order from a storage device having a higher transfer speed. In this case, when there is no free space in the data storage area of a storage device having the highest transfer speed, the host 10 causes a storage device having the second highest transfer speed to store the data. When there is a free space in a storage device having the Yth (Y is a natural number) highest transfer speed, and there is transferrable data in a storage device having the (Y+1)th highest transfer speed, the host 10 performs data transfer.

The host 10 can extract data having a less access frequency from the respective storage devices and transfer the data to one transfer-destination storage device. In this case, the host 10 turns off the transfer-destination storage device after the data has been transferred thereto.

According to the present embodiment, a case where the host 10 turns off a storage device having no stored data has been explained. However, the host 10 can switch a storage device having no stored data to a device sleep (DEVSLP) state. Alternatively, the host 10 can switch a storage device not accessed for a certain time (for example, 100 milliseconds) to a device sleep state.

According to the present embodiment, a case where the information processing system 1 includes six storage devices has been explained. However, the number of storage devices included in the information processing system 1 can be five or less, or can be seven or more. According to the present embodiment, a case where the information processing system 1 includes both the SSD and the HDD has been explained. However, the information processing system 1 can include either the SSD or the HDD. The information processing system 1 can include a data storage device other than the SSD and the HDD.

In this manner, according to the first embodiment, when the data transfer condition is satisfied, data transfer is performed from the transfer-source storage device to the transfer-destination storage device, and the transfer-source storage device is turned off, thereby enabling to perform data transfer at a high speed with low power consumption.

### Second Embodiment

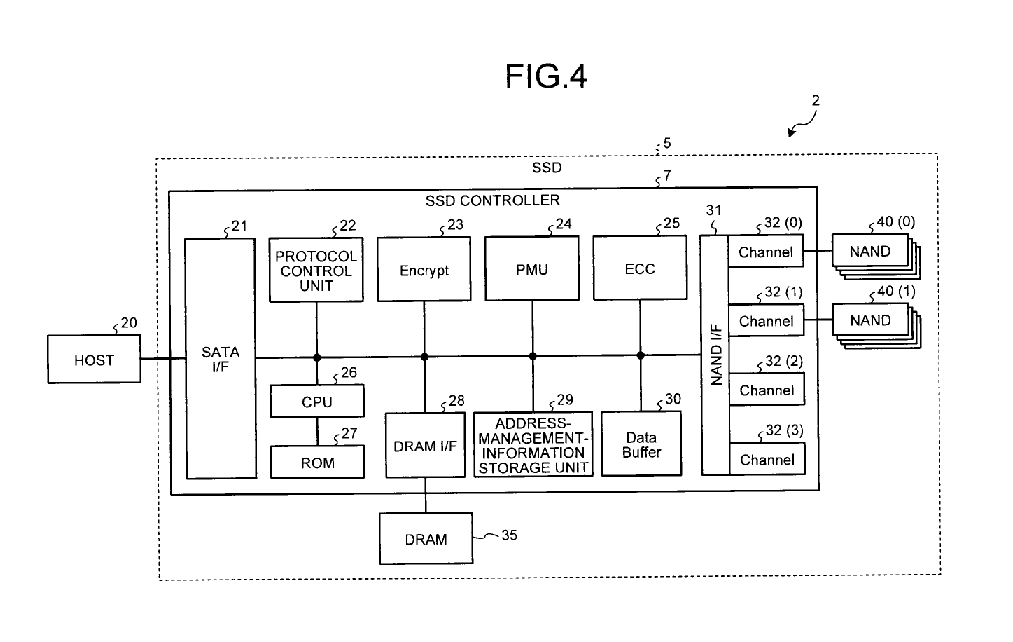

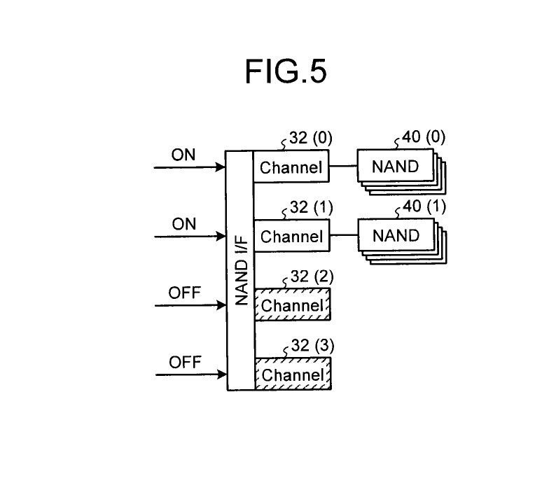

A second embodiment of the present invention is explained next with reference to FIGS. 4 and 5. According to the second embodiment, an unused Channel (a Channel with a use frequency lower than a predetermined value) is turned off. For example, a Channel not accessed for a predetermined period and a Channel to which a NAND memory is not physically connected externally are turned off. Accordingly, power consumption of the SSD is reduced. The Channel denotes one unit of an I/F portion for accessing the NAND memory.

FIG. 4 illustrates a configuration of a memory 2 includes a host (host device) 20 and an SSD 5. The SSD 5 includes an SSD controller 7, a DRAM 35, and NANDs 40(0) and 40(1).

The SSD controller 7 includes an SATA I/F 21, a protocol control unit 22, an Encrypt 23, a PMU 24, an ECC 25, a CPU 26, a ROM 27, a DRAM I/F 28, an address-management-information storage unit 29, a Data Buffer 30, a NAND I/F 31, and Channels 32(0) to 32(3) which are connected to each other via a bus. In the following explanations, the Channels 32(0) to 32(3) are respectively referred to as “Chs 32(0) to 32(3)”.

The CPU 26 executes control of the entire SSD controller 7 based on firmware (a firmware program) in the ROM 27. For example, the CPU 26 controls data transfer between the NANDs 40(0) and 40(1) and the DRAM 35. The ROM 27 stores therein the firmware and the like used for control of the SSD controller 7.

The address-management-information storage unit 29 stores therein address management information (LUT: Look Up Table) in which a logical address specified by the host 20 is associated with a physical address of data to be written in the NANDs 40(0) and 40(1). The address management information is referred to at the time of controlling data transfer between the NANDs 40(0) and 40(1) and the DRAM 35, and is updated after completion of data transfer.

The SATA I/F 21 is an interface that performs data communication with the host 20 according to the control by the CPU 26. The SATA I/F 21 transmits a command or data transmitted from the host 20 to the protocol control unit 22.

The DRAM I/F 28 accesses the DRAM 35 according to the control by the CPU 26. The NAND I/F 31 accesses the NANDs 40(0) and 40(1) being NAND memories via the Chs 32(0) to 32(1) according to the control by the CPU 26.

The protocol control unit 22 analyzes the command transmitted from the host 20 and notifies the CPU 26 of the command. The protocol control unit 22 transmits the data transmitted from the host 20 to the Encrypt 23.

The Encrypt 23 encrypts the data transmitted from the protocol control unit 22. The Encrypt 23 transmits the encrypted data to the DRAM 35 via the DRAM I/F 28.

The DRAM 35 is a volatile memory that temporarily stores therein the data transferred between the host 20 and the NANDs 40(0) and 40(1). The data temporarily stored in the DRAM 35 is transmitted to the ECC 25 via the DRAM I/F 28.

The ECC 25 is an ECC correction circuit for performing an error correction process of data to be written in the NANDs 40(0) and 40(1). The ECC 25 transmits the data subjected to the error correction process (data added with error correction information) to the Data Buffer 30.

The Data Buffer 30 is a memory that temporarily stores therein the data subjected to the error correction process. The data temporarily stored in the Data Buffer 30 is transmitted to either one of the NANDs 40(0) and 40(1) via the NAND I/F 31 and the Chs 32(0) to 32(1).

The Chs 32(0) to 32(3) are connected to the NAND I/F 31. The Chs 32(0) to 32(3) are respectively configured so that the NAND memories can be connected thereto. FIG. 4 illustrates a case where the NAND 40(0) is connected to the Ch 32(0), and the NAND 40(1) is connected to the Ch 32(1). FIG. 4 also illustrates a case where the NAND memory is not connected to the Chs 32(2) and 32(3).

The NANDs 40(0) and 40(1) are non-volatile memories. The NANDs 40(0) and 40(1) are configured to include one or a plurality of NAND memories. The NAND memory includes a memory cell array that stores therein write data from the host 20.

The PMU (Power Management Unit) 24 controls ON/OFF of the Chs 32(0) to 32(3) and other circuits. The NAND memory connected to the Channel of the Chs 32(0) to 32(3), which is turned on, is also turned on. According to the present embodiment, because the NAND memory is not connected to the Chs 32(2) and 32(3), the PMU 24 turns off the Chs 32(2) and 32(3). Accordingly, power consumption of the Chs 32(2) and 32(3) can be reduced.

FIG. 5 is an explanatory diagram of power ON/OFF setting of the Channel. For example, the SSD 5 turns off the Chs 32(2) and 32(3), which are Channels that are not connected with the NAND memory. In FIG. 5, hatching is added to the Chs 32(2) and 32(3), which are turned off.

In the memory system 2, the Channel is turned off by any of the following processes. When the Channel is turned off and when the NAND memory is connected to the Channel to be turned off, the NAND memory is also turned off.

(A) A user inputs information “1” indicating power-on of the Channel and information “0” indicating power-off of the Channel to the PMU 24 for each Channel. In this case, the PMU 24 turns on or off the Channel based on the information input by a user. In the following descriptions, “1” indicating power-on of the Channel and “0” indicating power-off of the Channel are referred to as “ON/OFF designation information”.

(B) The SSD controller 7 stores the ON/OFF designation information according to the presence or absence of wire bonding in an SSD controller package. In this case, at the time of manufacturing the SSD controller 7, “wire bonding” is set to the Channel connected with the NAND memory, and “wire bonding” is not set to the Channel not connected with the NAND memory. The PMU 24 turns on or off the respective Channels based on the ON/OFF designation information according to the presence or absence of the wire bonding.

(C) Either one of the NANDs 40(0) and 40(1) stores therein the ON/OFF designation information. In this case, at the time of manufacturing the SSD 5, “1” is set to the Channel connected with the NAND memory, and “0” is set to the Channel not connected with the NAND memory in the NANDs 40(0) and 40(1). The CPU 26 reads the ON/OFF designation information from the NANDs 40(0) and 40(1) and notifies the PMU 24 of the information. The PMU 24 turns on or off the respective Channels based on the ON/OFF designation information.

(D) The host 20 specifies the ON/OFF designation information with respect to the PMU 24. In this case, the ON/OFF designation information transmitted from the host 20 is transmitted to the PMU 24 via the protocol control unit 22 and the CPU 26. The PMU 24 turns on or off the respective Channels based on the ON/OFF designation information specified by the host 20.

(E) The PMU 24 turns off a Channel not accessed for a predetermined time or a Channel having a lower access frequency (a use frequency) than a predetermined value. In this case, the CPU 26 notifies the PMU 24 of the Channel to be turned off.

(F) When there is no response to a status read command with respect to the NANDs 40(0) and 40(1) for a predetermined time, the PMU 24 turns off the Channel. In this case, the CPU 26 notifies the PMU 24 of the Channel to be turned off. For example, because the status read command is issued at the time of startup of the SSD 5, the PMU 24 turns off the Channel at the time of startup of the SSD 5.

(G) When values of data (user data and system data such as log) stored in the NAND memory are all 0 or 1, the PMU 24 turns off the Channel. In this case, the NAND I/F 31 detects the value of data stored in the NAND memory and notifies the PMU 24 of the value. In normal use, a user can only access user data, of the data stored in the NAND memory.

After purchasing the SSD 5, only a value 0 is stored in the NANDs 40(0) and 40(1) until data is written in the NANDs 40(0) and 40(1). Therefore, the PMU 24 turns off the Chs 32(0) and 32(1).

When formatting of the NANDs 40(0) and 40(1) is performed, only a value 0 or 1 is stored in the NANDs 40(0) and 40(1), and thus the PMU 24 turns off the Chs 32(0) and 32(1) connected with the formatted NANDs 40(0) and 40(1).

(H) The PMU 24 turns off the Channel based on a write presence/absence table (not shown) representing the presence or absence of write of data stored in the NAND memory. At the time of manufacturing the SSD 5, information indicating there is no write is stored in the write presence/absence table of the NANDs 40(0) and 40(1). The PMU 24 turns on or off the respective Channels based on the write presence/absence table.

After purchasing the SSD 5, information indicating there is no write in the write presence/absence table is stored in the NANDs 40(0) and 40(1) until data is written in the NANDs 40(0) and 40(1). Therefore, the PMU 24 turns off the Chs 32(0) and 32(1). The PMU 24 also turns off the Channel having no write presence/absence table. When formatting of the NANDs 40(0) and 40(1) is performed, the information indicating there is no write in the write presence/absence table is stored in the NANDs 40(0) and 40(1), and thus the PMU 24 turns off the formatted Chs 32(0) and 32(1).

When the memory system 2 starts the operation, the SSD 5 receives a write command and write data from the host 20 via the SATA I/F 21, and causes the NANDs 40(0) and 40(1) to store therein the received data. The data received from the host 20 is allocated with an address (LBA: Logical Block Address). The LBA is converted to an actual address (physical address) on the NANDs 40(0) and 40(1) based on the LUT, thereby deciding a write address. At the time of reading, the LBA received from the host is converted to an address on the NANDs 40(0) and 40(1) based on the LUT, thereby deciding a read address. The read data is transferred to the host 20 through the SATA I/F 21.

According to the present embodiment, only the NAND memory being a write target is turned on, and other NAND memories are turned off. Accordingly, power consumption of the SSD 5 is reduced.

The data reading/writing speed of the SSD 5 is rate-limited by the speed of the NAND memory. That is, when data is read/written from/to the SSD 5, data reading speed and data writing speed with respect to the NAND memory becomes a bottleneck and the data reading/writing speed from/to the SSD 5 decreases. Therefore, to prevent a decrease in the data reading/writing speed, the SSD 5 has a plurality of Channels to the NAND memory. Accordingly, the SSD 5 can issue a separate command to the NAND memory connected to each Channel, and by using a Channel having finished a writing process or a reading process to/from the NAND memory, a decrease in the writing/reading speed to/from the NAND memory can be avoided. Furthermore, when the memory capacity of the SSD 5 is to be increased, the number of NAND memories can be increased. However, the number of NAND memories that can be connected to the Channel is predetermined due to a limitation of a load capacity of a terminal of the NAND memory. When the number of NAND memories is increased, the NAND memories that can be connected to the Channel can be increased, and thus the memory capacity of the SSD 5 increases.

Generally, to reduce the development cost of the SSD controller, one type of SSD controller is applied to the SSD having different memory capacities. In this case, even when the SSD does not use all the mounted Channels, the memory capacity corresponding to required specifications of the SSD product may be ensured. Alternatively, the SSD may be able to achieve the data reading/writing speed corresponding to the required specifications of the SSD product in a state of connection in which the number of Channels to be connected is less than the number of mounted Channels. In such a case, it is not always necessary to connect the NAND memory to all the Channels.

According to the present embodiment, by turning off the Channel to which the NAND memory does not need to be connected, power consumption is reduced without reducing the required access speed. On the other hand, when the circuit of the Channel is turned on even when the NAND memory is not actually connected thereto, as in the conventional manner, power consumption increases.

Another host interface different from the SATA I/F 21 can be arranged in the SSD controller 7. For example, an SAS I/F or a PCIe I/F can be arranged in the SSD controller 7. Alternatively, the SSD controller 7 can have a configuration in which an internal memory bus of a CPU in the host 20 is directly connected. Furthermore, another volatile memory different from the DRAM 35 or a high-speed non-volatile memory can arranged in the SSD controller 7, or another non-volatile memory different from the NANDs 40(0) and 40(1) can be arranged in the SSD controller 7. The non-volatile memory includes, for example, an NOR-type flash memory and an MRAM (Magnetic Random Access Memory).

The address-management-information storage unit 29 can be arranged outside of the SSD controller 7, and the Data Buffer 30 can be arranged outside of the SSD controller 7. In this case, the DRAM 35 can be used as the Data Buffer 30.

When a Channel that has been turned off needs to be turned on, the memory system 2 turns on the Channel. For example, when the NAND memory is connected to a Channel, which has been turned off because the NAND memory is not connected, the Channel is turned on. Further, when there is an access to a Channel, which has been turned off because there has been no access for a predetermined time, the Channel is turned on. At the time of turning on the Channel, the NAND memory connected to the Channel is also turned on.

In this manner, according to the second embodiment, because an unused Channel and a Channel not connected with the NAND memory are turned off, power consumption of the SSD 5 can be reduced.

### Third Embodiment

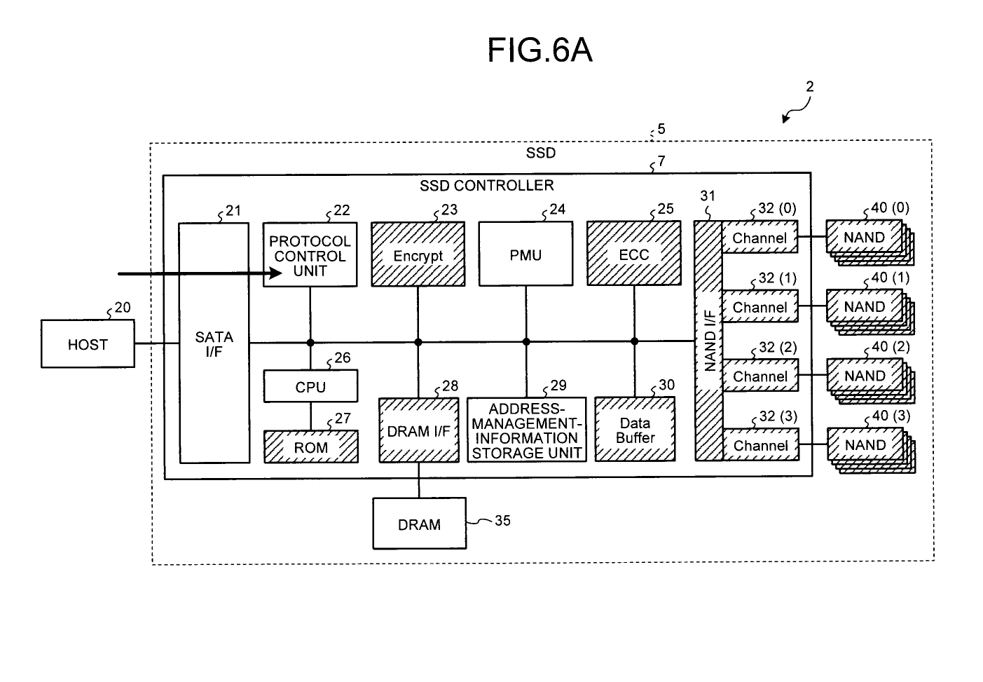

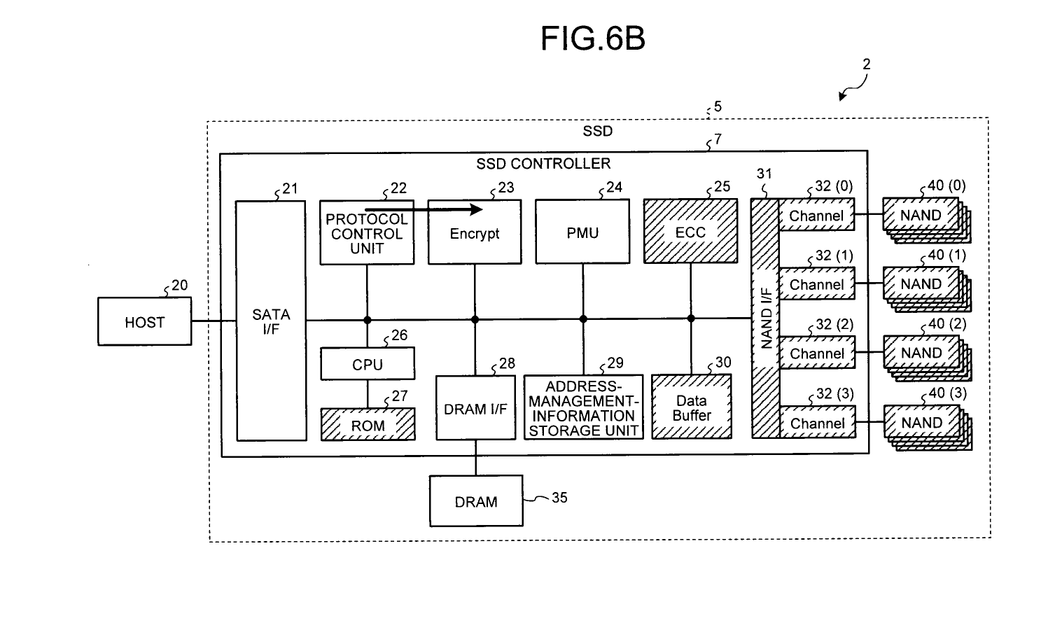

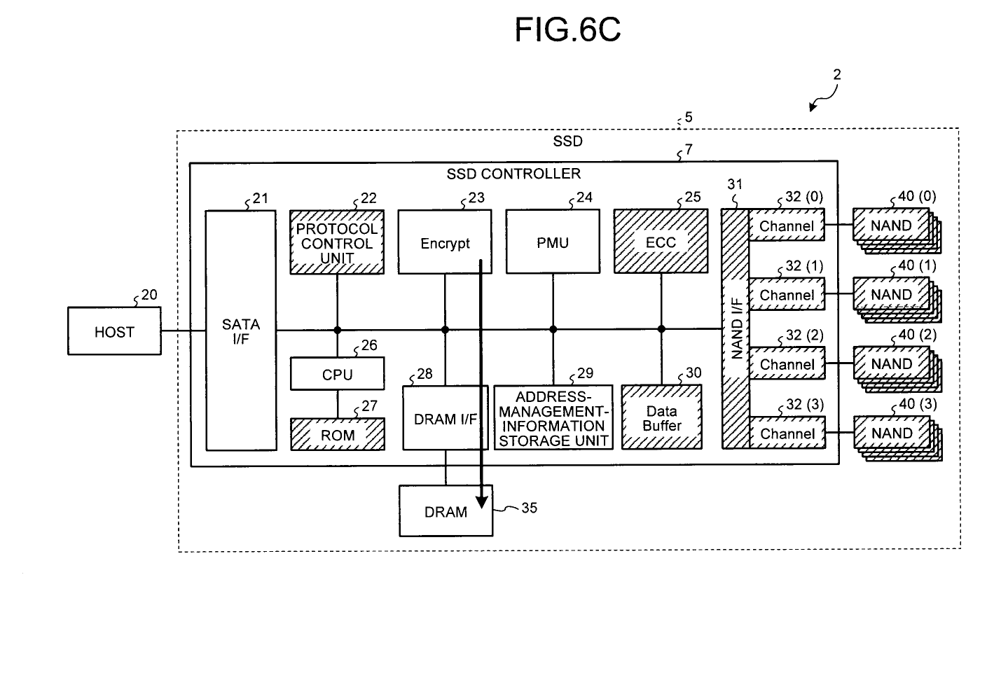

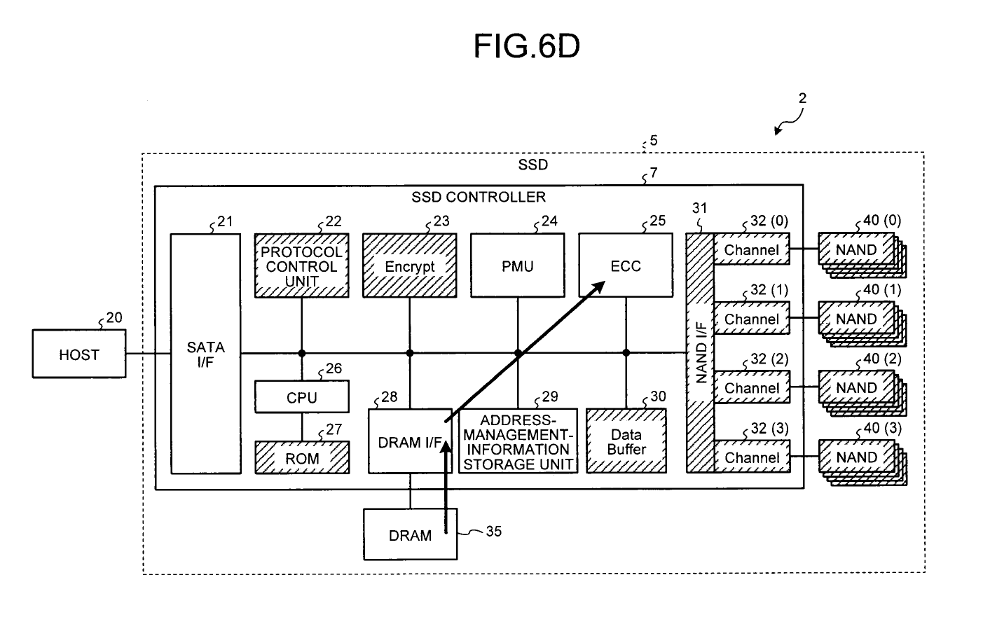

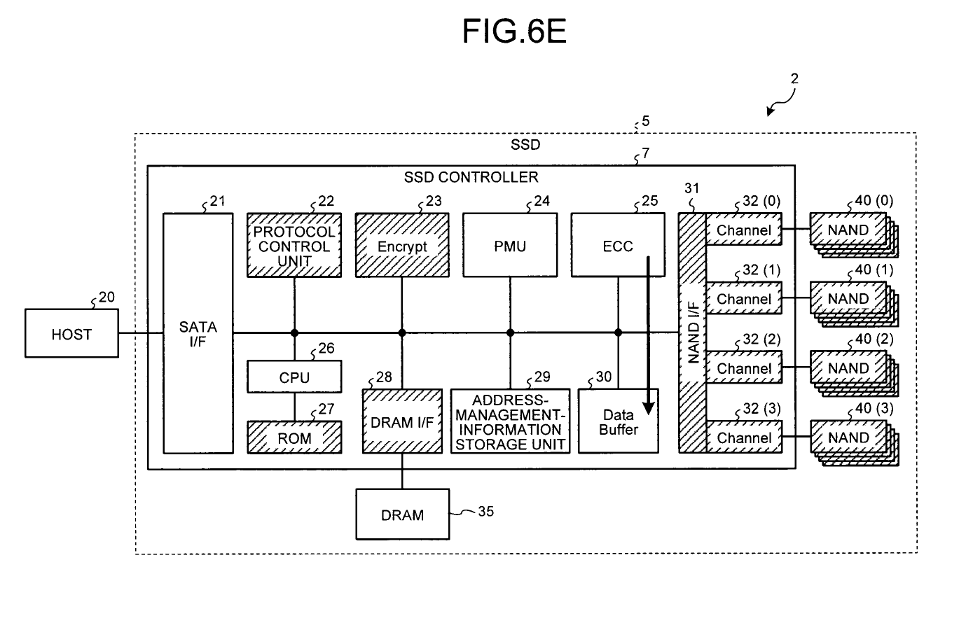

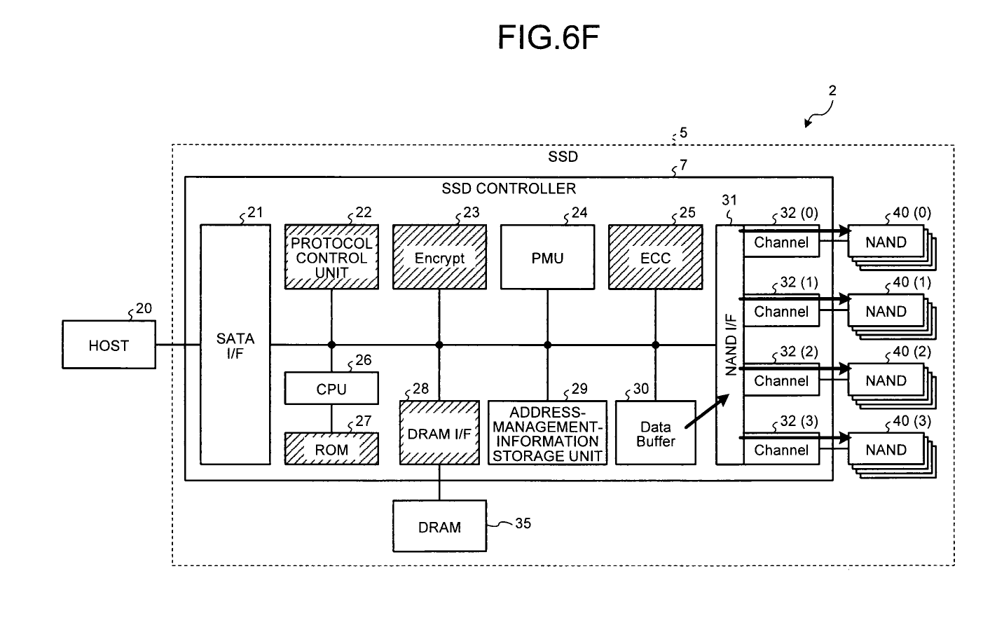

A third embodiment of the present invention is explained next with reference to FIGS. 6A to 6F. In a conventional SSD, although a circuit used for data processing such as writing and reading is only a part of the SSD controller, all the circuits of the SSD controller have been turned on, thereby consuming power wastefully in a circuit which is not involved with data write and data read. On the other hand, when the entire SSD controller is in a low-power consumption mode, there is a problem that the data processing speed decreases.

According to the third embodiment, when data flows from the SATA I/F 21 to the NAND memory, the PMU 24 turns on only a circuit required for processing of the data. Accordingly, the low-power consumption property of the SSD 5 can be realized without losing high-speed performance of data processing. In the present embodiment, a case where the NANDs 40(0) to 40(3) are connected to the memory system 2 is explained.

When data is written in the NANDs 40(0) to 40(3) via the SATA I/F 21, there is a significant difference in the transfer speed between the SATA I/F 21 and the NAND I/F 31. That is, the transfer speed between the host 20 and the SATA I/F 21 and the transfer speed between the NAND I/F 31 and the NANDs 40(0) to 40(3) is largely different. For example, in a case of an SATA Gen3, the transfer speed of the SATA I/F 21 is 600 MB/sec. However, the transfer speed of the NAND I/F 31 is about 100 MB/sec to 200 MB/sec. To absorb this difference, the SSD 5 accumulates data and commands from the SATA I/F 21 in the Data Buffer 30 or the DRAM 35. In the present embodiment, a buffer memory is arranged outside of the SSD controller 7. The Data Buffer 30 is formed of a DRAM or an SRAM being a volatile semiconductor memory; however, the Data Buffer 30 can be a cache area in the NANDs 40(0) to 40(3). Further, the Data Buffer 30 can be a non-volatile memory such as an FeRAM or an MRAM.

The SSD 5 writes data in the buffer memory in the NANDs 40(0) to 40(3) being a write target based on the accumulated commands. The SSD 5 also reads data from the NANDs 40(0) to 40(3) being a read target based on the accumulated commands. The SSD 5 also deletes data in the NANDs 40(0) to 40(3) being a delete target based on the accumulated commands. At the time of writing data in, reading data from, or deleting data from the NANDs 40(0) to 40(3), the SSD 5 uses the Chs 32(0) to 32(3).

The PMU 24 according to the third embodiment confirms the status of the command to the NANDs 40(0) to 40(3), which is accumulated in the buffer memory, and turns off a constituent element of the SSD 5 based on the confirmation result. For example, when there is no command to the Chs 32(0) to 32(3) in the buffer memory, the PMU 24 turns off the Chs 32(0) to 32(3), to which there is no command, thereby reducing power consumption.

Specifically, the PMU 24 turns off all the NANDs 40(0) to 40(3), in a state before data is written in the NANDs 40(0) to 40(3). The CPU 26 checks the address management information based on the address (LBA) of data received from the host 20, and refers to the LUT to check the physical address on the NANDs 40(0) to 40(3). The CPU 26 notifies the PMU 24 of the Channel in the NAND memory being a processing target. Accordingly, the PMU 24 turns on the NAND memory being a write target, and the CPU 26 writes data in the NAND memory that is turned on.

For example, when write data with respect to the Ch 32(0) is received, the PMU 24 turns off the circuits of the Chs 32(1) to 32(3), except for the circuit involved with the Ch 32(0).

When data is encrypted by the Encrypt 23, the PMU 24 turns off the circuits other than a circuit involved with the Encrypt 23, excluding the LUT. Furthermore, when data is to be encoded, the PMU 24 turns off the circuits other than a circuit involved with encoding. The PMU 24 can switch a part of the constituent elements of the SSD 5 to a low-power consumption mode, not only in a case where the PMU 24 turns off a part of the constituent elements of the SSD 5.

FIGS. 6A to 6F are explanatory diagrams of power ON/OFF setting in the SSD. According to the present embodiment, a case where the NANDs 40(0) to 40(3) are connected to the Chs 32(0) to 32(3) is explained. The power ON/OFF setting in the SSD 5 at the time of a writing process of data in the NANDs 40(0) to 40(3) is explained here; however similar ON/OFF setting is performed at the time of a reading process and a deleting process.

When the host 20 writes data in the NANDs 40(0) to 40(3) of the SSD 5, the SATA I/F 21, the protocol control unit 22, the PMU 24, the CPU 26, the address-management-information storage unit 29, and the DRAM 35 of the constituent elements of the SSD 5 are turned on at all times.

In FIG. 6A, power ON/OFF setting in the SSD 5 at the time of receiving data from the host 20 is shown. In FIGS. 6A to 6F, a shaded area indicates a power-off state. When the SSD 5 receives data from the host 20, the data is transmitted to the protocol control unit 22 via the SATA I/F 21.

In FIG. 6B, power ON/OFF setting in the SSD 5 at the time of encrypting data is shown. Upon reception of data from the host 20, the protocol control unit 22 transmits the data to the Encrypt 23. Immediately before the protocol control unit 22 transmits the data to the Encrypt 23, the PMU 24 turns on the Encrypt 23 and the DRAM I/F 28. When the data is transmitted to the Encrypt 23, the Encrypt 23 encrypts the data.

In FIG. 6C, power ON/OFF setting in the SSD 5 at the time of temporarily storing the encrypted data in the DRAM 35 is shown. When the protocol control unit 22 transmits the data to the Encrypt 23, the PMU 24 turns off the protocol control unit 22. The Encrypt 23 transmits the encrypted data to the DRAM 35 via the DRAM I/F 28. Accordingly, the DRAM 35 temporarily stores therein the data transmitted from the DRAM I/F 28.

In FIG. 6D, power ON/OFF setting in the SSD 5 at the time of performing error correction on the encrypted data is shown. When the Encrypt 23 transmits the data to the DRAM 35, the PMU 24 turns off the Encrypt 23. The DRAM 35 transmits the temporarily stored data to the ECC 25 via the DRAM I/F 28. The PMU 24 turns on the ECC 25 immediately before the DRAM 35 transmits the data to the ECC 25. Accordingly, the ECC 25 performs the error correction process of the data to be written in the NANDs 40(0) to 40(3).

In FIG. 6E, power ON/OFF setting in the SSD 5 at the time of temporarily storing the data in the Data Buffer 30 is shown. When the DRAM 35 transmits the data to the ECC 25 via the DRAM I/F 28, the PMU 24 turns off the DRAM I/F 28. The ECC 25 transmits the data subjected to the error correction process to the Data Buffer 30. The PMU 24 turns on the Data Buffer 30 immediately before the ECC 25 transmits the data to the Data Buffer 30. Accordingly, the Data Buffer 30 temporarily stores therein the data transmitted from the ECC 25.

In FIG. 6F, power ON/OFF setting in the SSD 5 at the time of writing data in the NANDs 40(0) to 40(3) is shown. When the ECC 25 transmits the data to the Data Buffer 30, the PMU 24 turns off the ECC 25. The Data Buffer 30 transmits the temporarily stored data to the NANDs 40(0) to 40(3) via the NAND I/F 31 and the Chs 32(0) to 32(3). The PMU 24 turns on the NAND I/F 31, the Chs 32(0) to 32(3), and the NANDs 40(0) to 40(3) immediately before the Data Buffer 30 transmits the data to the NAND I/F 31. Accordingly, the NANDs 40(0) to 40(3) store therein the data from the host 20.

The PMU 24 can turn on only the power of the NAND I/F 31, the Chs 32(0) to 32(3), and the NANDs 40(0) to 40(3) to be used for writing the data, and can turn off other constituent elements.

When there are a plurality of ECCs 25, for example, the ECC for data write and the ECC for data read, the PMU 24 can set ON/OFF of power for each ECC. In this case, at the time of data write, the ECC for data write is turned on, and the ECC for data read is turned off. At the time of data read, the ECC for data read is turned on and the ECC for data write is turned off.

In this manner, according to the third embodiment, because a circuit not required for data processing is turned off based on a command instructing data processing, power consumption of the SSD 5 can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a first storage device;
a second storage device; and
a host device that controls the first and second storage devices, wherein
when a first condition is satisfied, the host device transfers data stored in the first storage device to the second storage device, turns off the first storage device after the transfer, and when it is required to perform data processing by the first storage device, turns on the first storage device.

2. The information processing system according to claim 1, wherein
the first storage device is an SSD or an HDD, and
the second storage device is an SSD or an HDD.

3. The information processing system according to claim 1, wherein the first condition is that power consumption for operating the first storage device is higher than a first power value, and power consumption for operating the second storage device is lower than a second power value.

4. The information processing system according to claim 1, wherein the first condition is that an access frequency to the first storage device in a first predetermined period is lower than a first value, and an access frequency to the second storage device in a second predetermined period is higher than a second value.

5. The information processing system according to claim 1, wherein the first condition is that an amount of data stored in the first storage device is smaller than a first amount, and an amount of data stored in the second storage device is larger than a second amount.

6. The information processing system according to claim 1, wherein the first condition is that a data transfer speed of the first storage device is lower than a first speed, and a data transfer speed of the second storage device is higher than a second speed.

7. The information processing system according to claim 6, wherein
the first storage device is connected to the host device via a PCIe interface or a memory bus of a CPU in the host, and
the second storage device is connected to the host device via an SATA interface or an SAS interface.

8. The information processing system according to claim 1, further comprising a third storage device, wherein
when a second condition is satisfied, the host device divides data stored in the third storage device and transfers the divided data to the first storage device and the second storage device, and after the transfer, turns off the third storage device, and when it is required to perform data processing by the third storage device, turns on the third storage device.

9. The information processing system according to claim 1, further comprising a fourth storage device, wherein
when a third condition is satisfied, the host device transfers data stored in the first and second storage devices to the fourth storage device, and after the transfer, turns off the first and second storage devices, and when it is required to perform data processing by the first and second storage devices, turns on the first and second storage devices.

10. The information processing system according to claim 1, further comprising a fifth storage device, wherein
when a fourth condition is satisfied, the host device transfers data, which is stored in the first or second storage device and has a lower access frequency in a predetermined period than a third value, to the fifth storage device, and after the transfer, turns off the fifth storage device, and when it is required to perform data processing by the fifth storage device, turns on the fifth storage device.

11. A storage device comprising:
a plurality of non-volatile memories;
a plurality of channels connectable to the non-volatile memories in one-to-one correspondence; and
a control unit that controls the non-volatile memories, wherein
the storage device that can be connected to a host device and
the control unit has a power control unit that turns off a channel connected to a first non-volatile memory of the non-volatile memories, the first non-volatile memory having an access frequency lower than a predetermined value.

12. The storage device according to claim 11, wherein the power control unit turns off a first channel of the plurality of channels, the first channel being not connected to any of the non-volatile memories.

13. The storage device according to claim 11, wherein the power control unit turns off a second channel of the plurality of channels, the second channel being specified by a user.

14. The storage device according to claim 11, further comprising a storage unit that stores therein information of a channel to be turned off, of the plurality of channels, wherein
the power control unit turns off the channel based on the information.

15. The storage device according to claim 11, wherein the power control unit turns off a third channel of the plurality of channels, the third channel being specified by a command received from the host device.

16. The storage device according to claim 11, wherein when a response to a status read command is not returned from a second non-volatile memory of the plurality of non-volatile memories within a predetermined time, the power control unit turns off a forth channel of the plurality of channels, a forth channel being connectable to the second non-volatile memory.

17. The storage device according to claim 11, wherein when values of data stored in a second non-volatile memory of the plurality of non-volatile memories and accessible from the host device are all zero or one, the power control unit turns off a fifth channel of the plurality of channels, the fifth channel being connectable to the second non-volatile memory.

18. A storage device comprising:
a plurality of non-volatile memories;
a plurality of channels connectable to the non-volatile memories in one-to-one correspondence; and
a control unit that controls the non-volatile memories; and
a buffer that stores therein a command received from a host device, wherein
the storage device that can be connected to the host device and
the control unit has a power control unit that turns off a predetermined circuit included in the control unit based on a command stored in the buffer.

19. The storage device according to claim 18, wherein the power control unit turns on a channel connectable to a non-volatile memory, which is to be accessed based on the command stored in the buffer, of the plurality of non-volatile memories.

20. The storage device according to claim 18, wherein the buffer is a DRAM, an SRAM, or a cache area included in the plurality of non-volatile memories.
